(19) United States
(12) Patent Application Publication
(10) Pub. No.: US 2026/0003659 A1
(43) Pub. Date: Jan. 1, 2026

(54) OFFLOADING CONTAINER RUNTIME ENVIRONMENT ORCHESTRATION

(71) Applicant: Amazon Technologies, Inc., Seattle, WA (US)

(72) Inventors: Christopher Grover Baker, Marianna, FL (US); Swagat Bora, Seattle, WA (US); Carl Hamilton Hiltbrunner, Seattle, WA (US); Anirudh Balachandra Aithal, Bothell, WA (US); Nenghui Fang, Southborough, MA (US); Malcolm Featonby, Sammamish, WA (US); Lee Spencer Dillard, Seattle, WA (US)

(21) Appl. No.: 18/759,558

(22) Filed: Jun. 28, 2024

(51) Int. Cl. G06F 9/455; G06F 9/48; G06F 9/50

(52) U.S. Cl. CPC G06F 9/45558; G06F 9/4881; G06F 9/5027; G06F 2009/45575; G06F 2009/45591; G06F 2209/509

(57) ABSTRACT

Disclosed are systems and methods that offload the work traditionally performed by a thick software client operating on each container instance of a cloud provider network with a thin and generalized agent that can be instructed in a piece-wise manner to perform operations as instructed by a workload manager executing on a control plane that is separate from the container instance. The workload manager, executing on the control plane of a cloud provider network, may precompute a set of operations and order of execution of those operations in the control plane and present those operations in a controlled manner to the agent that executes each operation as instructed. The agent executing on the data plane, rather than polling an orchestrator for work and then establishing the runtime environment based on a received Application Specification, awaits an operation or task that is pushed to the agent from the control plane.

### BACKGROUND

Containers are a popular means of packaging and executing workloads across different computing environments, such as on-premise and in a cloud computing environment. Traditionally, containers leverage operating system primitives combined with a standardized packaging format to package code and a manifest which describes the runtime requirements of a process or workload. Building on this, Container Orchestrators like Kubernetes®, Nomad®, and ECS® provide declarative means, also referred to herein as an Application Specification, to describe an application environment which comprises one or more containerized workloads including the provisioning order, runtime relationship, resource requirements, resource sharing and collaboration between containerized workloads in order to deliver a complete running application. Each orchestrator has its own declarative language to describe an Application Specification—for Kubernetes this is a Pod Specification, for ECS it is a Task Definition, for Nomad this is a Job Specification. Currently, managing the provisioning of this runtime environment is done with a thick software client, specific to each orchestrator, running on each server or container instance. The thick software client polls the orchestrator for work and accepts that orchestrators Application Specification from the controlling service and uses the specification to choreograph a running set of processes on the server to achieve a desired state. To achieve the desired state the thick software client, based on its own knowledge of the operating system and computing environment, leverages a set of calls to the operating system to configure process namespaces, network namespaces and file system mounts which combine to comprise the application's runtime environment.

### BRIEF DESCRIPTION OF THE DRAWINGS

FIGS. 1A-1C are drawings of examples of a container execution environment, in accordance with disclosed implementations.

FIGS. 2A and 2B are schematic block diagrams of example networked environments, in accordance with disclosed implementations.

FIG. 3 is an example run container set process, in accordance with disclosed implementations.

FIG. 4 is an example transition diagram of instructing an agent of a container instance to complete a series of operations to configure a container instance for a container set, in accordance with disclosed implementations.

FIG. 5 is an example process for updating portions of a control plane of the example networked environments of FIGS. 2A and/or 2B, in accordance with disclosed implementations.

FIG. 6 is a schematic block diagram that provides one example illustration of a cloud provider network employed in the example networked environments of FIGS. 2A and/or 2B, in accordance with disclosed implementations.

### DETAILED DESCRIPTION

Existing approaches for provisioning and orchestrating containerized workloads typically rely on complex software agents running on each compute instance to interpret workload specifications and carry out the provisioning steps. This increases the overhead and management burden on the instances themselves. For example, the thick software client consumes both memory and compute resources in the data plane rather than those resources being available for the client application. Additionally, the workload specifications are often tied to specific orchestration platforms, limiting portability across different runtime environments like virtual machines, serverless functions, and container services. Because each thick software client is specific to and only communicates with a corresponding orchestrator, multiple thick client agents must reside on each server to support different runtimes, again consuming resources. There is a need for a more lightweight, standardized, and formally verifiable way to provision containerized workloads in a consistent manner across heterogeneous runtime environments.

The above challenges, among others, are addressed by the disclosed systems and techniques for decoupling the specification of containerized workload requirements from the underlying orchestration logic. The disclosed systems and techniques introduce a container universal runtime descriptor (“CURD”) that declaratively defines the desired state of a containerized workload in a standardized format. This CURD can then be interpreted by a centralized control plane to generate a state machine definition language (“SMDL”) tailored for the target runtime environment. Formal methods can be applied to verify the correctness of the CURD and/or SMDL specifications. The SMDL can encapsulate the precise sequence of low-level (“foundational”) operations needed to provision the workload, which can then be executed by a lightweight client on the target compute instance. This approach simplifies the on-instance components, enhances portability across runtimes, and enables potential performance optimizations by offloading orchestration complexity to the control plane.

The present disclosure relates to a container execution environment that may be deployed in cloud provider networks. More specifically, the present disclosure relates to the establishment of a generic compute primitive specializing in hosting containerized workloads. There is a significant amount of commonality between Application Specifications that are generated by different orchestrators to orchestrate the establishment of a runtime environment for a workload, also referred to herein as an application. As discussed herein, the disclosed implementations provide a more universal shared modeling language or runtime descriptor, referred to herein as a CURD, that can be leveraged as a common language for all orchestrators. Still further, with the disclosed implementations, the orchestrator-specific thick software client operating on every container instance is replaced with a thin and generalized agent that can be instructed in a piece-wise manner to perform operations as instructed by a workload manager executing on a control plane that is separate from the container instance. As discussed further below, the workload manager executing on the control plane of a cloud provider network may precompute a set of operations and order of execution of those operations in the control plane layer and present those operations in a controlled manner to the agent, operating on the data plane, that executes each operation as instructed. The agent executing on the server, rather than polling an orchestrator for work and then establishing the runtime environment based on a received Application Specification, awaits an operation that is pushed to the agent. When the agent receives an operation, the agent performs the operation and then provides a notification, also referred to herein as an acknowledgement, back to the workload manager on the control plane that the operation is complete. The workload manager may then determine and send a next operation for execution by the agent. This exchange may continue until each operation determined by the workload manager has been pushed to and performed by the agent and the desired runtime environment state is established for the container set on the container instance.

As discussed further below, the disclosed implementations provide a technical improvement to the operating of the cloud computing network and corresponding computing infrastructure. For example, the disclosed implementations remove the thick software agent from the data plane layer thereby freeing up resources, such as memory and compute, for client applications. Likewise, by moving the determination and orchestration of operations to be performed to establish a desired state for a container set to the control plane, security is increased and the ability to audit and validate the establishment of the desired state becomes possible. Still further, software patches and updates are greatly simplified. For example, traditional software updates or patches to the thick software client had to be performed for each individual thick software client executed on each of the different servers. In comparison, because the orchestration traditionally performed by the thick software client is performed by a workload manager executing on the control plane layer and potentially communicating with multiple agents on different servers, that single workload manager may be updated without the need to update any of the agents. As still another example, with the disclosed implementations, the on-host agent is significantly simpler and has a much smaller software footprint than the traditional thick software clients, thereby reducing testing burden and improving system integrity. In addition, the smaller software footprint of the on-host agent meaningfully reduces the surface area of software running on the host server, thereby improving server efficiency and security.

Containers are an increasingly popular computing modality within cloud computing. A container represents a logical packaging of a software application that abstracts the application from the computing environment in which the application is executed. For example, a containerized version of a software application includes the software code and any dependencies used by the code such that the application can be executed consistently on any infrastructure hosting a suitable container engine (e.g., DOCKER, CRI-O, CONTAINERD, RKT, PODMAN). Existing software applications can be “containerized” by packaging the software application in an appropriate manner and generating other artifacts (e.g., a container image, container file, other configurations) used to enable the application to run in a container engine. A container instance, as used herein, refers to a virtual or physical machine within the cloud provider network that may be or is configured to run one or more containerized applications.

While virtual machine instances have been available for many years in cloud provider networks and other computing environments, developers are now moving to containers to package and deploy computational resources to run applications at scale. Containers embody operating system-level virtualization instead of system hardware-level virtualization. In contrast to virtual machine instances that include a guest operating system, containers share a host operating system and include only the applications and their dependencies. Thus, containers are far more lightweight, and container images may be megabytes in size as opposed to virtual machine images that may be gigabytes in size. For this reason, containers are typically launched much faster than virtual machine instances (e.g., milliseconds instead of minutes) and are more efficient for ephemeral use cases where containers are launched and terminated on demand.

Various implementations of the present disclosure introduce a container execution environment that can allow for stateful containers and support live migration. The container execution environment executes the container control plane, including the container runtime and/or the container orchestration agent, separately from the operating system and machine instance that hosts or executes the container. Likewise, as discussed herein, the container control plane can include a workload manager that determines the operations and order of operations necessary to transition a container instance from a current state to a desired state that is necessary to run a containerized application. In one implementation, the container control plane is executed by a dedicated hardware processor that is separate from the processor on which the operating system and container executes. In another implementation, the container control plane is executed in a first virtual machine instance that is different from a second virtual machine instance in which the operating system and container instance are executed. As will be described, these arrangements allow the container control plane components, including the workload manager, to be updated without terminating the application, container, container instance, and/or other operations on the data plane. Additionally, the container execution environment may include a block data storage service to load container images more quickly and allow for stateful container instances to be persisted as images.

While the implementations discussed herein are primarily focused on transitioning a container instance from a current state to a desired state that is necessary to run a containerized application, the disclosed implementations are equally applicable to transitioning a container instance from a current state to a desired state that is necessary for other actions that are to be performed with respect to a container instance. For example, the disclosed implementations may be utilized to shut down a running application, which may include transitioning the container instance from a current state in which the application is running to a desired state in which the application is shut down. As another example, the disclosed implementations may be utilized to update a running application, which may include transitioning the container instance from a current state in which the application is running to a desired state in which the application has been updated and is running in an updated state. Accordingly, it will be appreciated that the disclosed implementations are operable to transition a container instance from a current state to any desired state and not just a desired state in which an application is running on the container instance. Examples of transitions from a current state to a desired state of a container instance include, but are not limited to, transitioning a container instance from a current state of not running to a desired state of running, transitioning a container instance from a current state of running to a desired state of not running, transitioning a container instance from a current state of a first configuration to a desired state of a second configuration that is different than the first configuration, transitioning a container instance from a current state of running to a desired state of back to running (e.g., for in-flight patching), transitioning a container instance from a current state of running an application to a desired state of running an updated version of the application, etc.

A container, as referred to herein, packages up code and all its dependencies so an application (also referred to as a task, pod, or cluster in various container services) can run quickly and reliably from one computing environment to another. A container image is a standalone, executable package of software that includes everything needed to run an application process: code, runtime, system tools, system libraries and settings. Container images become containers at runtime. Containers are thus an abstraction of the application layer (meaning that each container simulates a different software application process). Though each container runs isolated processes, multiple containers can share a common operating system, for example by being launched within the same virtual machine or within the same container instance. In contrast, virtual machines are an abstraction of the hardware layer (meaning that each virtual machine simulates a physical machine that can run software). Virtual machine technology can use one physical server to run the equivalent of many servers (each of which is called a virtual machine). While multiple virtual machines can run on one physical machine, each virtual machine typically has its own copy of an operating system, as well as the applications and their related files, libraries, and dependencies. Virtual machines are commonly referred to as compute instances, container instances, or simply “instances.”

Containers are comprised of several underlying kernel primitives: namespaces (what other resources the container is allowed to talk to), cgroups (the amount of resources the container is allowed to use), and LSMs (Linux Security Modules—what the container is allowed to do). Tools referred to as “container runtimes” make it easy to compose these pieces into an isolated, secure execution environment. A container runtime, also referred to as a container engine, manages the complete container lifecycle of a container, performing functions such as image transfer, image storage, container execution and supervision, and network attachments, and from the perspective of the end user, the container runtime runs the container. As discussed further below, the workflow manager, operating in the container control plane, may process the container runtime and determine discrete operations and an order of those operations that are to be performed by an agent operating on a container instance to configure the container instance for the containerized application.

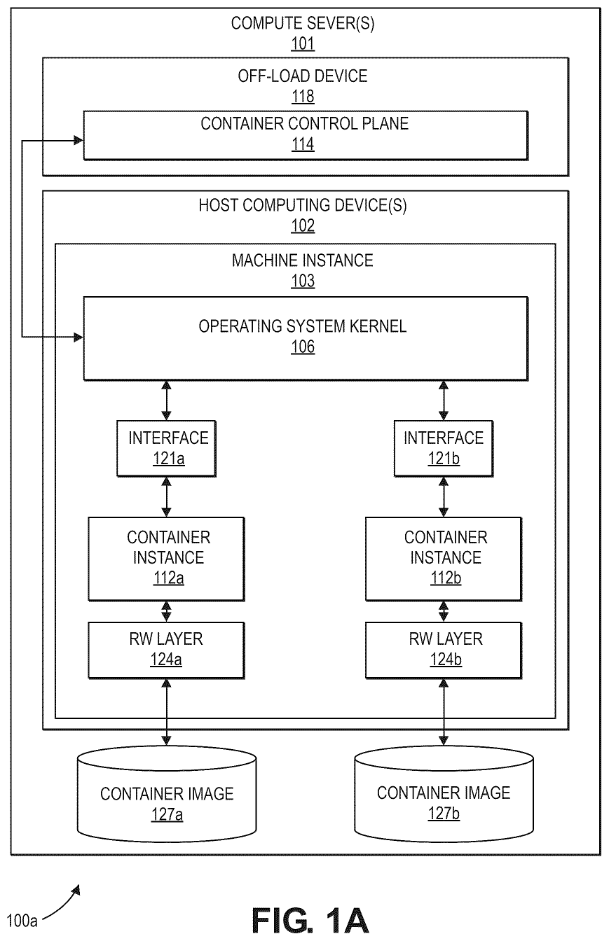

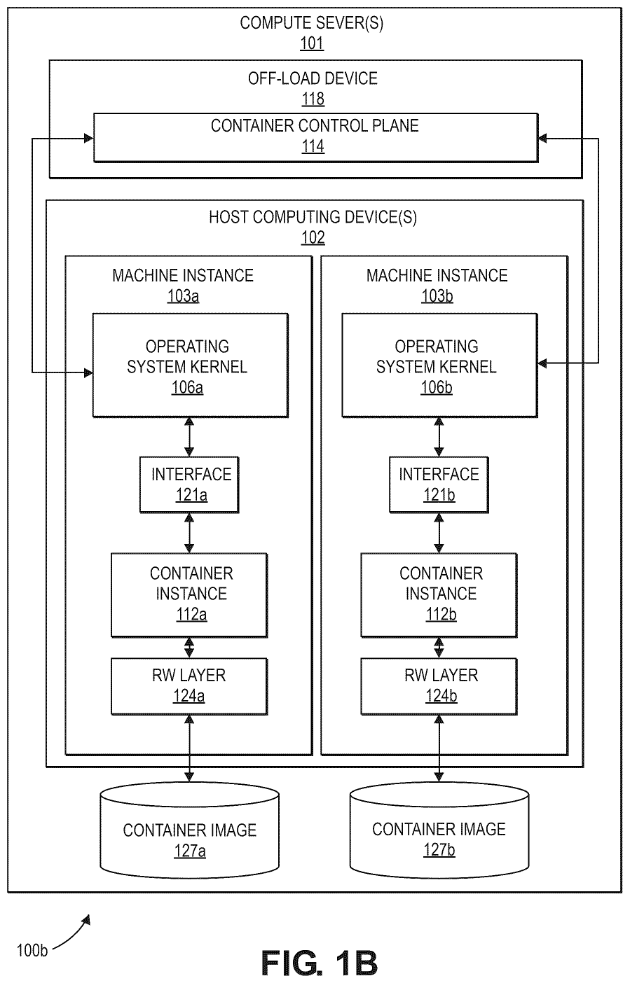

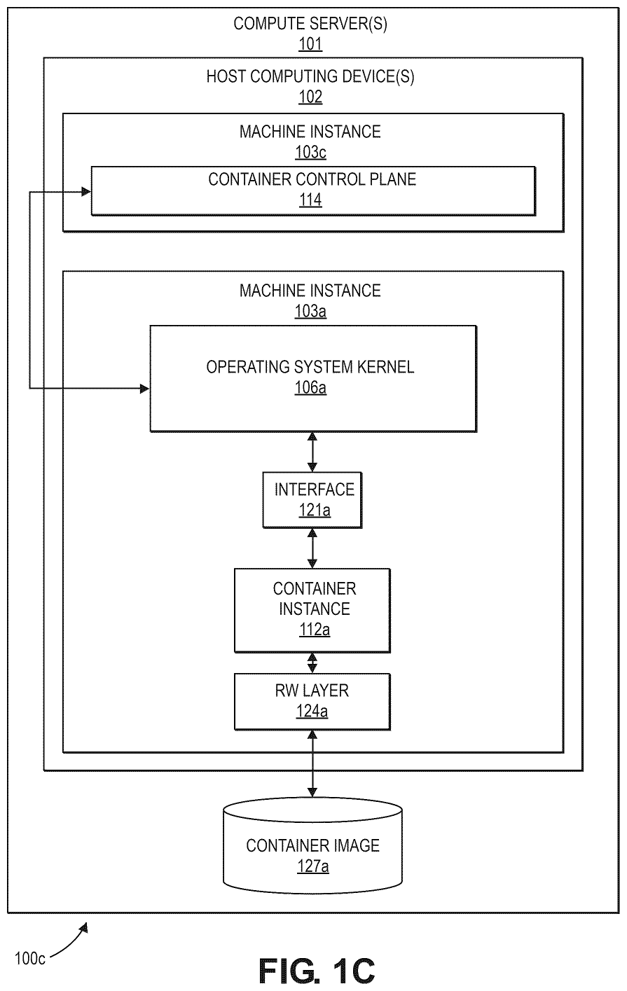

Referring now to FIG. 1A, shown is one example of a container execution environment 100a according to various implementations. In FIG. 1A, a machine instance 103 executes an operating system kernel 106 and a plurality of container instances 112a and 112b. The container instances 112 may correspond to a pod or group of containers. A container control plane 114 manages the container instances 112 by providing operating system-level virtualization to the container instances 112 via a container runtime, with orchestration implemented by a workstation manager executing in the control plane 114 that is pushing discrete operations to an agent executing on the container instance 112.

Rather than have the container control plane 114 execute in the same machine instance 103 as the container instances 112, the control plane 114 can instead be executed in an off-load device 118 corresponding to special purpose computing hardware in the same computing server(s) 101 in which the machine instance 103 is executed. The container control plane 114 can be run as software on general purpose processors of the off-load device 118, implemented directly in hardware through the design of custom integrated circuits or microchips, or a combination thereof. In some implementations, at least a subset of virtualization management tasks may be performed at one or more off-load devices 118 (e.g., off-load card(s)) coupled to a host computing device(s) 102 so as to enable more of the processing capacity of the host computing device(s) 102 to be dedicated to client-requested compute instances—e.g., cards connected via PCI or PCIe to the physical CPUs and other components of the virtualization host may be used for some virtualization management components. Such an off-load device 118 of the host computing device(s) 102 can include one or more CPUs that are not available to customer instances, but rather are dedicated to instance management tasks such as virtual machine management (e.g., a hypervisor, or an operating system of the hypervisor), input/output virtualization to network-attached storage volumes, local migration management tasks, instance health monitoring, and the like. The off-load device 118 can function as a network interface card (NIC) of the host computing device 102 in some implementations, and can implement encapsulation protocols to route packets.

Interface 121a and 121b provides a lightweight application programming interface (API) shim to send calls and responses between the control plane 114 executed in the off-load device 118 and the operating system kernel 106 and the container instances 112 executed in the machine instance 103. In some implementations, system security is enhanced by using the off-load device 118 in that a security compromise of the memory storing the container instances 112 would be isolated to that memory and would not extend to the container control plane 114 in the off-load device 118.

Additionally, respective read/write layers 124a and 124b enable the corresponding container instances 112a and 112b to read from and write to data storage, such as a block data storage service, that includes a respective container image 127a and 127b. As the state inside the container instances 112 is modified or changed, the containers of the container instances 112 having the modified state can be serialized and stored as the container images 127, thereby permitting the containers to be stateful rather than stateless. The container images 127 may be included in the compute server(s) 101, as illustrated in FIG. 1A, such as stored in memory of the compute server(s) 101, and/or stored on one or more remote devices, such as a remote block storage service (“EBS”) or a distributed container image cache.

Turning to FIG. 1B, shown is another example of a container execution environment 100b according to various implementations. FIG. 1B, in contrast to FIG. 1A, shows a container execution environment 100b with a plurality of machine instances 103a and 103b, which may each execute respective operating system kernels 106a and 106b and one or more respective container instances 112a and 112b. For example, the machine instances 103 may be executed on the same host computing device 102 or on different host computing devices 102. A single container control plane 114 executed in the off-load device 118 may perform the operating system-level virtualization for the container instances 112 in both of the machine instances 103a and 103b. In some cases, the machine instances 103 may correspond to different customers or accounts of a cloud provider network, with the machine instances 103 being a tenancy boundary.

Moving now to FIG. 1C, shown is another example of a container execution environment 100c according to various implementations. Instead of executing the container control plane 114 in an off-load device 118 of the host computing device(s) 102, as in FIGS. 1A and 1B, the container execution environment 100c executes the container control plane 114 in a different machine instance 103c. The machine instances 103a and 103c may be executed in the same host computing device(s) 102, as illustrated in FIG. 1C, or in different host computing devices. In one implementation, the machine instance 103c may correspond to a cloud provider network substrate. In the following discussion, a general description of the system and its components is provided, followed by a discussion of the operation of the same.

As will be appreciated, the configurations illustrated and discussed with respect to FIGS. 1A through 1C are examples only and other configurations may be utilized with the disclosed implementations.

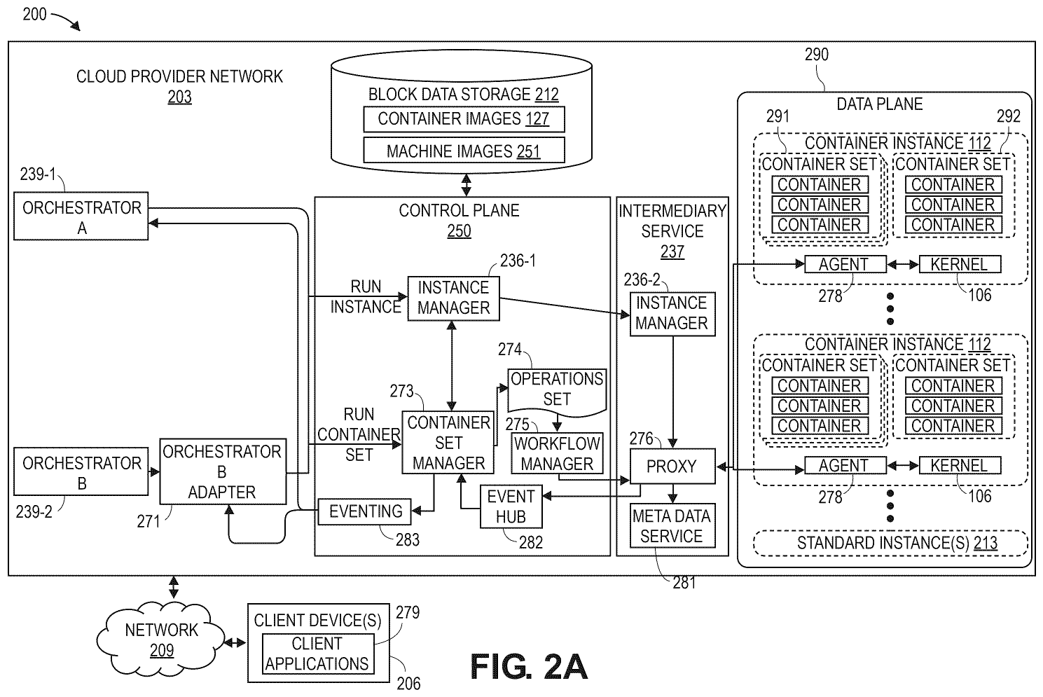

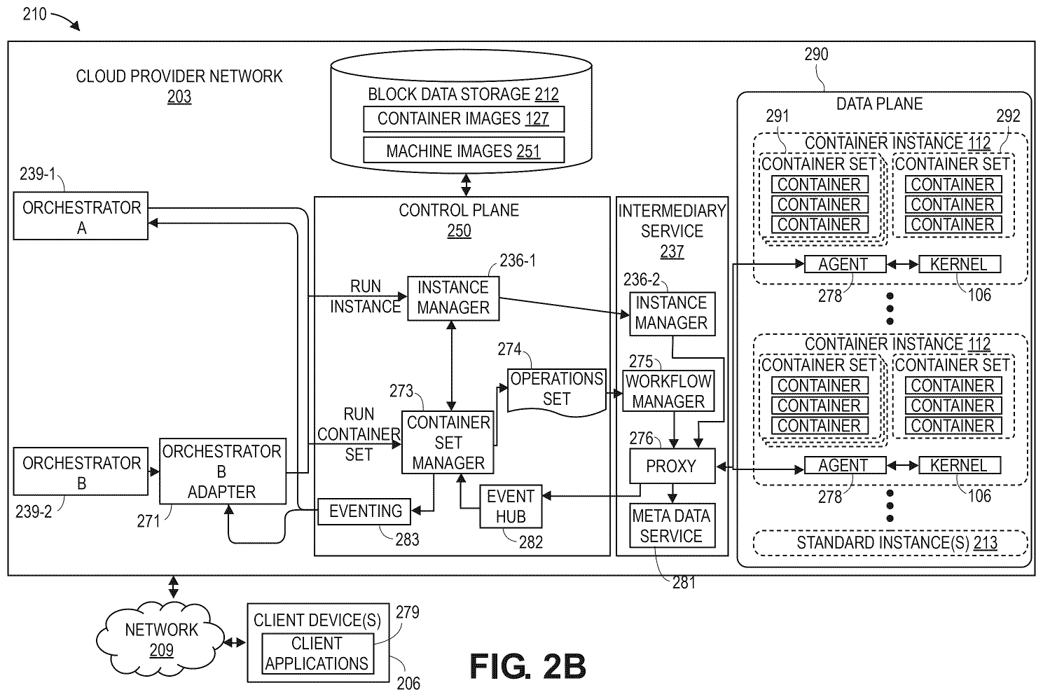

With reference to FIGS. 2A and 2B, shown are example configurations of a networked environment 200/210, in accordance with disclosed implementations.

The networked environment 200/210 includes a cloud provider network 203 and one or more client devices 206, which are in data communication with each other via a network 209. The network 209 includes, for example, the Internet, intranets, extranets, wide area networks (WANs), local area networks (LANs), wired networks, wireless networks, cable networks, satellite networks, or other suitable networks, etc., or any combination of two or more such networks.

A cloud provider network 203 (sometimes referred to simply as a “cloud”) refers to a pool of network-accessible computing resources (such as compute, storage, and networking resources, applications, and services), which may be virtualized or bare-metal. The cloud can provide convenient, on-demand network access to a shared pool of configurable computing resources that can be programmatically provisioned and released in response to customer commands. These resources can be dynamically provisioned and reconfigured to adjust to a variable load. Cloud computing can thus be considered as both the applications delivered as services over a publicly accessible network (e.g., the Internet, a cellular communication network) and the hardware and software in cloud provider data centers that provide those services.

As used herein, provisioning a virtual compute instance (also referred to herein as an instance) generally includes reserving resources (e.g., computational and memory resources) of an underlying physical compute instance for the client (e.g., from a pool of available physical compute instances and other resources), installing or launching required software (e.g., an operating system), and making the virtual compute instance available to the customer for performing tasks specified by the customer.

The cloud provider network 203 can provide on-demand, scalable computing systems to users through a network, for example, allowing users to have at their disposal scalable “virtual computing devices” via their use of the compute servers (which provide compute instances via the usage of one or both of central processing units (CPUs) and graphics processing units (GPUs), optionally with local storage) and block data storage services 212 (which provide virtualized persistent block storage for designated compute instances). These virtual computing devices have attributes of a personal computing device including hardware (various types of processors, local memory, random access memory (RAM), hard-disk, and/or solid-state drive (SSD) storage), a choice of operating systems, networking capabilities, and pre-loaded application software. Each virtual computing device may also virtualize its console input and output (e.g., keyboard, display, and mouse). This virtualization allows users to connect to their virtual computing device using a computer application such as a browser, API, software development kit (SDK), or the like, in order to configure and use their virtual computing device just as they would a personal computing device. Unlike personal computing devices, which possess a fixed quantity of hardware resources available to the user, the hardware associated with the virtual computing devices can be scaled up or down depending upon the resources the user requires.

As indicated above, users can connect to virtualized computing devices and other cloud provider network 203 resources and services using one or more application programming interfaces (APIs). An API refers to an interface and/or communication protocol between a client device 206 and a server, such that if the client makes a request in a predefined format, the client should receive a response in a specific format or cause a defined action to be initiated. In the cloud provider network context, APIs provide a gateway for customers to access cloud infrastructure by allowing customers to obtain data from or cause actions within the cloud provider network 203, enabling the development of applications that interact with resources and services hosted in the cloud provider network 203. APIs can also enable different services of the cloud provider network 203 to exchange data with one another. Users can choose to deploy their virtual computing systems to provide network-based services for their own use and/or for use by their customers or clients.

The cloud provider network 203 can include a physical network (e.g., sheet metal boxes, cables, rack hardware) referred to as the substrate. The substrate can be considered as a network fabric containing the physical hardware that runs the services of the provider network. The substrate may be isolated from the rest of the cloud provider network 203, for example it may not be possible to route from a substrate network address to an address in a production network that runs services of the cloud provider, or to a customer network that hosts customer resources.

The cloud provider network 203 can also include an overlay network of virtualized computing resources that run on the substrate. In at least some implementations, hypervisors or other devices or processes on the network substrate may use encapsulation protocol technology to encapsulate and route network packets (e.g., client IP packets) over the network substrate between client resource instances on different hosts within the provider network. The encapsulation protocol technology may be used on the network substrate to route encapsulated packets (also referred to as network substrate packets) between endpoints on the network substrate via overlay network paths or routes. The encapsulation protocol technology may be viewed as providing a virtual network topology overlaid on the network substrate. As such, network packets can be routed along a substrate network according to constructs in the overlay network (e.g., virtual networks that may be referred to as virtual private clouds (VPCs), port/protocol firewall configurations that may be referred to as security groups). A mapping service can coordinate the routing of these network packets. The mapping service can be a regional distributed look up service that maps the combination of an overlay internet protocol (IP) and a network identifier to a substrate IP so that the distributed substrate computing devices can look up where to send packets.

To illustrate, each physical host device (e.g., a compute server, a block store server, an object store server, a control server) can have an IP address in the substrate network. Hardware virtualization technology can enable multiple operating systems to run concurrently on a host computer, for example as virtual machines (VMs) and/or lightweight micro-virtual machines (“microVM”) on a compute server. A hypervisor, or virtual machine monitor (VMM), on a host allocates the host's hardware resources amongst various VMs on the host and monitors the execution of the VMs. Each VM may be provided with one or more IP addresses in an overlay network, and the VMM on a host may be aware of the IP addresses of the VMs on the host. The VMMs (and/or other devices or processes on the network substrate) may use encapsulation protocol technology to encapsulate and route network packets (e.g., client IP packets) over the network substrate between virtualized resources on different hosts within the cloud provider network 203. The encapsulation protocol technology may be used on the network substrate to route encapsulated packets between endpoints on the network substrate via overlay network paths or routes. The encapsulation protocol technology may be viewed as providing a virtual network topology overlaid on the network substrate. The encapsulation protocol technology may include the mapping service that maintains a mapping directory that maps IP overlay addresses (e.g., IP addresses visible to customers) to substrate IP addresses (IP addresses not visible to customers), which can be accessed by various processes on the cloud provider network 203 for routing packets between endpoints.

The VMMs enable the launch of microVMs in non-virtualized environments in fractions of a second. These VMMs can also enable container runtimes and container orchestrators to manage containers as microVMs. These microVMs nevertheless take advantage of the security and workload isolation provided by traditional VMs and the resource efficiency that comes along with containers, for example by being run as isolated processes by the VMM. A microVM, as used herein, refers to a VM initialized with a limited device model and/or with a minimal operating system (“OS”) kernel that is supported by the VMM, and which can have a low memory overhead of less than five mebibyte (“MiB”) per microVM such that thousands of microVMs can be packed onto a single host. For example, a microVM can have a stripped down version of an OS kernel (e.g., having only the required OS components and their dependencies) to minimize boot time and memory footprint. In one implementation, each process of the VMM encapsulates one and only one microVM. The process can run the following threads: API, VMM and vCPU(s). The API thread is responsible for the API server and associated control plane. The VMM thread exposes a machine model, minimal legacy device model, microVM metadata service (“MMDS”), and VirtIO device emulated network and block devices. In addition, there are one or more vCPU threads (one per guest CPU core). A microVM can be used in some implementations to run a containerized workload.

The traffic and operations of the cloud provider network substrate may broadly be subdivided into two categories in various implementations: control plane traffic carried over a logical control plane 250 and data plane operations carried over a logical data plane 290. In some implementations, an intermediary service 237 may reside between the control plane 250 and the data plane 290 to facilitate communication and operations between the control plane 250 and the data plane 290. In some implementations, the intermediary service 237 may physically reside on the same hardware or instances as the data plane 290 but be logically separate from the data plane 290 and/or the control plane 250. In other implementations, the intermediary service 237 may reside on the same hardware or instances of the control plane but be logically separate from the control plane 250 and/or the data plane 290. In other implementations, some or all of the intermediary service 237 may be incorporated into the control plane 250, some or all of the intermediary service 237 may be incorporated into the data plane 290, and/or some or all of the intermediary service 237 may be incorporated into both the control plane 250 and the data plane 290.

While the data plane 290 represents the movement of user data through the distributed computing system, the control plane 250 represents the movement of control signals through the distributed computing system. The control plane generally includes one or more control plane components or services distributed across and implemented by one or more control servers. Control plane traffic generally includes administrative operations, such as establishing isolated virtual networks for various customers, monitoring resource usage and health, identifying a particular host or server at which a requested compute instance is to be launched, provisioning additional hardware as needed, and so on. Likewise, in accordance with the disclosed implementations, determination and orchestration of discrete operations to be performed by an agent 278 of a container instance 112 on the data plane 290 may be managed by a workflow manager 275 executing on the control plane 250.

The data plane 290 includes customer resources that are implemented on the cloud provider network 203 (e.g., computing instances, containers, block storage volumes, databases, file storage). Data plane traffic generally includes non-administrative operations such as transferring data to and from the customer resources. As illustrated, the data plane 290 may be a heterogenous environment hosting any of a variety of customer resources such as container instances 112 and non-container instances, referred to herein as standard instances 213, such as a virtual machine.

The control plane components are typically implemented on a separate set of servers from the data plane servers, and control plane traffic and data plane traffic may be sent over separate/distinct networks. In some implementations, control plane traffic and data plane traffic can be supported by different protocols. In some implementations, messages (e.g., packets) sent over the cloud provider network 203 include a flag to indicate whether the traffic is control plane traffic or data plane traffic. In some implementations, the payload of traffic may be inspected to determine its type (e.g., whether control or data plane). Other techniques for distinguishing traffic types are possible.

The data plane 290 can include one or more computing devices, which may be bare metal (e.g., single tenant) or may be virtualized by a hypervisor to run multiple VMs, machine instances, microVMs, and/or container instances 112 for one or more customers. These compute servers can support a virtualized computing service (or “hardware virtualization service”) of the cloud provider network 203, referred to in various implementations as an elastic compute cloud service, an elastic compute service, a virtual machines service, a computing cloud service, a compute engine, or a cloud compute service. As used herein, the term “elastic” refers to the ability to scale the number of concurrently used resources up or down on demand.

The virtualized computing service may be part of the control plane 250, allowing customers to issue commands via an API to launch and manage compute instances (e.g., VMs, containers) for their applications. The virtualized computing service may offer virtual compute instances (also referred to as virtual machines or simply “instances”) with varying computational and/or memory resources, which are managed by a compute virtualization service (referred to in various implementations as an elastic compute service, a virtual machines service, a computing cloud service, a compute engine, or a cloud compute service). In one implementation, each of the virtual compute instances managed by the virtualized computing service may correspond to one of several instance families. A compute instance family or container instance family may be characterized by its hardware type, computational resources (e.g., number, type, and configuration of CPUs or CPU cores), memory resources (e.g., capacity, type, and configuration of local memory), storage resources (e.g., capacity, type, and configuration of locally accessible storage), network resources (e.g., characteristics of its network interface and/or network capabilities), and/or other suitable descriptive characteristics (such as being a “burstable” instance type that has a baseline performance guarantee and the ability to periodically burst above that baseline, or a non-burstable or dedicated instance type that is allotted and guaranteed a fixed quantity of resources). Each instance family can have a specific ratio of processing, local storage, memory, and networking resources, and different instance families may have differing types of these resources as well. Multiple sizes of these resource configurations can be available within a given instance family, referred to as “instance types.” Using instance type selection functionality, an instance type may be selected for a customer, e.g., based (at least in part) on input from the customer. For example, a customer may choose an instance type from a predefined set of instance types. As another example, a customer may specify the desired resources of an instance type and/or requirements of a workload that the instance will run, and the instance type selection functionality may select an instance type based on such a specification.

It will be appreciated that such virtualized instances may also be able to run in other environments, for example on the premises of customers, where such on-premise instances may be managed by the cloud provider or a third party. In some scenarios the instances may be microVMs. The cloud provider network may offer other compute resources in addition to instances and microVMs, for example containers (which may run in instances or bare metal) and/or bare metal servers that are managed by a portion of a cloud provider service running on an offload card of the bare metal server.

The data plane 290 can also include one or more volumes hosted by block store servers, which can include persistent storage for storing volumes of customer data, as well as software for managing these volumes. These block store servers can support a block data storage service 212 of the cloud provider network 203. Such a block data storage service 212 can be referred to in various implementations as an elastic block store service, a cloud disks service, a managed disk service, a cloud block storage service, a persistent disk service, or a block volumes service.

The block data storage service 212 may be part of the control plane, allowing customers to issue commands via the API to create and manage volumes for their applications running on compute instances 112. The block store servers include one or more servers on which data is stored as blocks. A block is a sequence of bytes or bits, usually containing some whole number of records, having a maximum length of the block size. Blocked data is normally stored in a data buffer and read or written a whole block at a time. In general, a volume can correspond to a logical collection of data, such as a set of data maintained on behalf of a user. User volumes, which can be treated as an individual hard drive ranging for example from 1 GB to 1 terabyte (TB) or more in size, are made of one or more blocks stored on the block store servers. Although treated as an individual hard drive, it will be appreciated that a volume may be stored as one or more virtualized devices implemented on one or more underlying physical host devices. Volumes may be partitioned a small number of times (e.g., up to 16) with each partition hosted by a different host.

In general, a volume can correspond to a logical collection of data, such as a set of data maintained on behalf of a user. A virtualized block storage volume can be referred to in various implementations as a cloud disk, storage disk, cloud volume, disk, block volume, or simply “volume.”

The data of a volume may be erasure coded and/or replicated between multiple devices within a distributed computing system, in order to provide multiple replicas of the volume (where such replicas may collectively represent the volume on the computing system). Replicas of a volume in a distributed computing system can beneficially provide for automatic failover and recovery, for example by allowing the user to access either a primary replica of a volume or a secondary replica of the volume that is synchronized to the primary replica at a block level, such that a failure of either the primary or secondary replica does not inhibit access to the information of the volume. The role of the primary replica can be to facilitate reads and writes (sometimes referred to as “input output operations,” or simply “I/O operations”) at the volume, and to propagate any writes to the secondary (preferably synchronously in the I/O path, although asynchronous replication can also be used). The secondary replica can be updated synchronously with the primary replica and provide for seamless transition during failover operations, whereby the secondary replica assumes the role of the primary replica, and either the former primary is designated as the secondary or a new replacement secondary replica is provisioned. Although these examples discuss a primary replica and a secondary replica, it will be appreciated that a logical volume can include multiple secondary replicas.

As used herein, a server or drive “hosting” a volume refers to that storage device storing at least a portion (e.g., a partition, a set of blocks) of the data of the volume and implementing instructions for managing that portion of the volume (e.g., handling I/O to and from the volume, replication of the volume, transfer of volume data to and from other storage systems). “Attachment” between a volume and an instance refers to the establishment of a connection between a client of the instance and the volume. This connection may be referred to as a “lease” in some implementations, and it enables the instance to view the volume as if it were a local storage drive, even though the volume and instance may be hosted on different physical machines and communicating over a network. At the virtual machine instance host, a “client” may maintain the attachment to the volume and the I/O requests from the virtual machine to the volume. The client represents instructions that enable a compute instance to connect to, and perform I/O operations at, a remote data volume (e.g., a data volume stored on a physically separate computing device accessed over a network). The client may be implemented on an offload card that is connected to and controls the server that includes the processing units (e.g., CPUs or GPUs) of the compute instance, such as off-load device 118.

The computing devices may have various forms of allocated computing capacity, which may include virtual machine (VM) instances, containers, serverless functions, and so forth. The VM instances may be instantiated from a VM image. To this end, customers may specify that a virtual machine instance should be launched in a particular type of computing device as opposed to other types of computing devices. In various examples, one VM instance may be executed singularly on a particular computing device, or a plurality of VM instances may be executed on a particular computing device. Also, a particular computing device may execute different types of VM instances, which may offer different quantities of resources available via the computing device. For example, some types of VM instances may offer more memory and processing capability than other types of VM instances.

A cloud provider network 203 can be formed as a plurality of regions, where a region is a separate geographical area in which the cloud provider has one or more data centers. Each region can include two or more availability zones (AZs) connected to one another via a private high-speed network such as, for example, a fiber communication connection. An availability zone refers to an isolated failure domain including one or more data center facilities with separate power, separate networking, and separate cooling relative to other availability zones. A cloud provider may strive to position availability zones within a region far enough away from one another such that a natural disaster, widespread power outage, or other unexpected event does not take more than one availability zone offline at the same time. Customers can connect to resources within availability zones of the cloud provider network 203 via a publicly accessible network (e.g., the Internet, a cellular communication network, a communication service provider network). Transit Centers (TC) are the primary backbone locations linking customers to the cloud provider network 203 and may be co-located at other network provider facilities (e.g., Internet service providers, telecommunications providers). Each region can operate two or more TCs for redundancy. Regions are connected to a global network which includes private networking infrastructure (e.g., fiber connections controlled by the cloud service provider) connecting each region to at least one other region. The cloud provider network 203 may deliver content from points of presence (PoPs) outside of, but networked with, these regions by way of edge locations and regional edge cache servers. This compartmentalization and geographic distribution of computing hardware enables the cloud provider network 203 to provide low-latency resource access to customers on a global scale with a high degree of fault tolerance and stability.

Various applications and/or other functionality may be executed in the cloud provider network 203 according to various implementations. The components executed on the cloud provider network 203, for example, include one or more instance managers 236-1, 236-2, one or more container orchestration services 239-1, 239-2, one or more orchestrator adaptors 271, one or more container set managers 273, one or more workflow managers 275, and/or other applications, services, processes, systems, engines, or functionality not discussed in detail herein.

The instance managers 236-1/236-2 are executed to coordinate and manage a pool of machine instances in the cloud provider network 203 in order to provide a container execution environment 100 (FIGS. 1A-1C). The instance managers 236-1/236-2 may monitor the usage of the container execution environment 100 and scale the quantity of machine instances up or down as demand warrants. In some implementations, the instance manager 236-1/236-2 may also manage substrate machine instances and/or off-load devices 118 in the cloud provider network 203. This may entail scaling a quantity of substrate machine instances up or down as demand warrants, deploying additional instances of components in the control plane 114, based on demand, moving the components of the container control plane 114 to higher or lower capacity substrate machine instances and/or to and from the off-load devices 118.

The container set manager 273 receives calls from the orchestrator 239-1/239-2 and, in response, may determine the state of a container instance and validate that inputs included in the call from the orchestrator are valid. The call, which may include an Application Specification, may then be converted by the container set manager 273 into an operations set 274 or state model that specifies a sequence or order of steps that are to be pushed to the agent 278 to take actions against the kernel 106 to transition the container instance to a desired state that can run the container requested by the orchestrator, referred to herein as desired runtime state.

The workflow manager 275, executing on the control plane 250, based on the operations and order specified in the operations set 274, pushes operations through the proxy 276 to the agent 278 and those operations are performed by the agent. The workflow manager 275 may communicate through the proxy 276 with multiple different agents 278 of different container instances, may communicate with multiple different proxies 276 that interface with multiple different agents 278 of different container instances, etc. In some implementations, the workflow manager 275 may reside in the control plane 250, as illustrated in FIG. 2A. In other implementations, some or all of the workflow manager 275 may reside in the intermediary service 237, as illustrated in FIG. 2B. For example, the workflow manager and/or some or all of the intermediary service 237 may reside in physical hardware that also hosts or runs the data plane 290. For example, a first portion of hardware may host the data plane 290 while the workflow manager resides on a second physically distinct portion of hardware, such as a side card (e.g., graphics processing unit) of the computing hardware that is operating the data plane 290. Effectively, in such configurations, the workflow manager 275 functions as a portion of the control plane within the data plane and functions as a portion of the data plane within the control plane. Regardless of the physical location of the workflow manager 275, the workflow manager 275 is logically separate from the container instance(s) 112.

The event hub 282, which may execute on the control plane 250, may be configured to keep track of control plane operations, data stores, events, telemetry, and publish events back up to the data plane 290 or the orchestrator, for example through eventing 283.

The agent 278 is a minimal or thin agent that may be agnostic of the data plane infrastructure or the orchestrator. For example, calls from any of the different types of orchestrator may be sent to and executed by the agent 278, in accordance with the disclosed implementations.

The proxy 276 is a service that that may be configured to execute on the hardware with the agent 278 to ensure stability and low latency for orchestration. The proxy may be configured to receive operations, instructions, or other commands pushed from the workflow manager 275 and provide those operations, instructions, commands to the agent 278 for execution. As discussed above, the proxy 276 may receive commands from the workflow manager 275 and send those commands to any one of multiple different agents 278 operating on different container instances 112 within the data plane 290. The meta data service 281 allows the infrastructure cloud provider network to provide information to compute instances, container instances, etc., about the cloud provider network 203.

The container orchestration service 239-1/239-2 is executed to manage the lifecycle of containers, including provisioning, deployment, scaling up, scaling down, networking, load balancing, and other functions. In accordance with the disclosed implementations, the container orchestration services 239-1/239-2 accomplishes these functions by way of a container set manager 273 executing on the control plane 250, workflow manager 275 executing on the control plane and agents 278 that are deployed typically on the same machine instance as the container instance 112. In various implementations, the agents 278 are deployed on computing capacity that is separate from the machine instance on which the container instance 112 is executed, for example, on a substrate machine instance. Non-limiting examples of commercially available container orchestration services 239-1/239-2 include KUBERNETES, APACHE MESOS, DOCKER orchestration tools, and so on. An individual instance of the container orchestration service 239-1/239-2 may manage container instances 112 for a single customer or multiple customers of the cloud provider network 203. Likewise, in some implementations, the Application Specification generated by an orchestration service, such as orchestration service B 239-2 may be processed by an orchestrator adapter 271 that converts the Application Specification to a CURD that can then be interpreted by the container set manager 273 to generate an SMDL that may be utilized by the container set manager 273 to generate an operations set and an expression of target state (e.g., running, paused, restarted, stopped). In other implementations, the orchestrator adapter 271 may generate the CURD and resultant SMDL that is then provided to the container set manager. Regardless, different orchestrator adapters 271 may be used for different orchestrators to convert the Application Specification generated by those orchestrators to the CURD and/or SMDL. In other implementations, the Application Specification from an orchestration service may be converted to CURD and/or SMDL by components other than the orchestrator adapter, such as by the container set manager 273 and/or other components operating within the control plane 250. In some implementations, the container set manager 273 and/or other components of the control plane 250 may verify the correctness of the CURD and/or the SMDL using one or more formal methods to ensure that the CURD and resulting SMDL correspond to the Application Specification received from the orchestrator 239. Likewise, the container set manager and/or workflow manager 275 may also audit and/or verify that actions performed by the agent 278 are completed correctly and accurately.

The block data storage 212 provides block data service for the machine instances. In various implementations, the block data storage 212 stores container images 127, machine images 251, and/or other data. Some implementations may additionally or alternatively use other types of storage systems or services for such images and data, for example object storage or databases. Such images may also be stored in, and accessed/deployed from, an image registry, for example by being pulled from the image registry into the block storage 212 of a machine instance that will host the container. The container images 127 correspond to container configurations created by customers, which include applications and their dependencies. The container images 127 can be compatible with one or more types of operating systems. In some cases, the container images 127 can be updated with a modified state of a container. In some implementations, the container images 127 are compatible with an Image Specification from the Open Container Initiative.

The machine images 251 correspond to physical or virtual machine system images, including an operating system and supporting applications and configurations. The machine images 251 may be created by the cloud provider and may not be modified by customers. The machine images 251 are capable of being instantiated into the machine instances or the substrate machine instances.

The machine instances perform the container execution for the container execution environments 100. In various examples, the machine instances may include an operating system kernel 106, one or more control plane interfaces, such as a container runtime interface and/or a container agent interface or proxy 276, a meta data service 281, one or more container instances 112, a read/write layer 124, etc. The operating system kernel 106 may correspond to a LINUX, BSD, or other kernel in various examples. The operating system kernel 106 may manage system functions such as processor, memory, input/output, networking, and so on, through system calls and interrupts. The operating system kernel 106 may include a scheduler that manages concurrency of multiple threads and processes. In some cases, a user space controller provides access to functions of the operating system kernel 106 in user space as opposed to protected kernel space. The proxy 276 may act as communication interfaces allowing the operating system kernel 106, agent 278, and/or the container instances 112 to communicate with the components of the control plane 250, such as the workflow manager 275.

The read/write layer 124 provides the container instances 112 with access to the block data storage service 212, potentially through a mapped drive or other approach for providing block data to the container instance 112.

Substrate machine instances may be executed in the substrate of the cloud provider network 203 to provide a separate execution environment for instances of the components of the control plane 250, including the container set manager 273 and the workflow manager 275.

The client device 206 is representative of a plurality of client devices that may be coupled to the network 209. The client device 206 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, smartwatches, head mounted displays, voice interface devices, or other devices. The client device 206 may include a display that may comprise, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The client device 206 may be configured to execute various applications such as a client application 279 and/or other applications. The client application 279 may be executed in a client device 206, for example, to access network content served up by the cloud provider network 203 and/or other servers, thereby rendering a user interface on the display. To this end, the client application 279 may comprise, for example, a browser, a dedicated application, etc., and the user interface may comprise a network page, an application screen, etc. The client device 206 may be configured to execute applications beyond the client application 279 such as, for example, email applications, social networking applications, word processors, spreadsheets, and/or other applications.

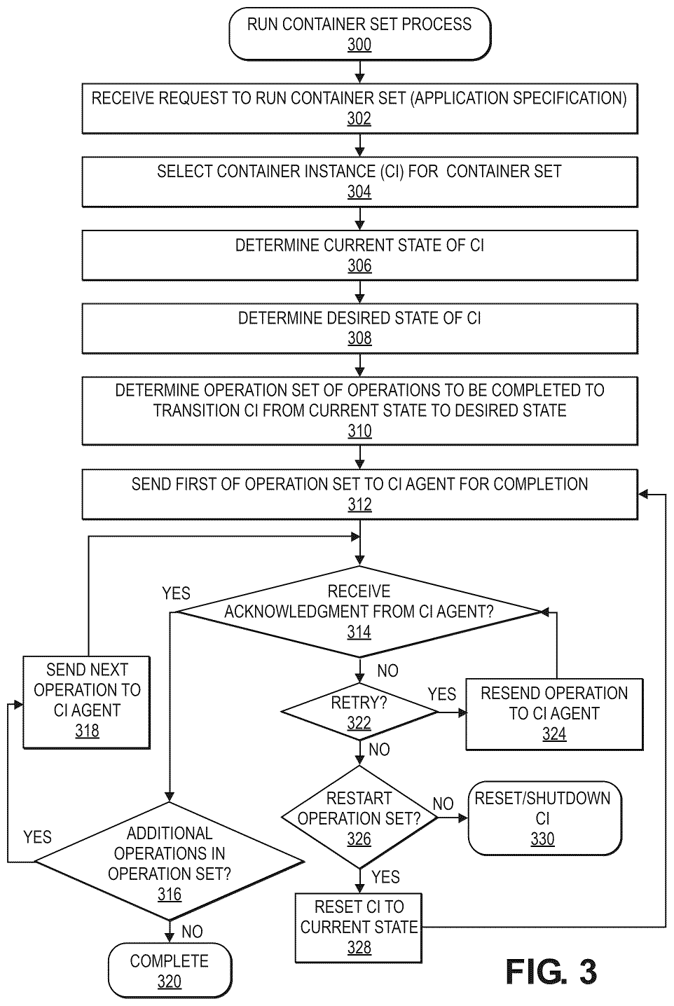

FIG. 3 is an example run container set process 300, in accordance with disclosed implementations. The entire process 300 may be performed on the control plane of the cloud provider network. For example, the container set manager 273 and/or the workflow manager 275 may perform some or all of the example process 300.

The example process 300 begins upon receipt of a request to run a container set, as in 302. For example, if a customer submits a request to run a containerized application to an orchestrator, the orchestrator may generate and send an application specification corresponding to that application. In accordance with the disclosed implementations, that application specification may be received and, if necessary, converted by an orchestrator adapter into a CURD that is then interpreted into a standardized SMDL application specification. In other implementations, the orchestrator may provide the application specification already prepared in a CURD and/or interpreted into an SMDL application specification.

Upon receipt of the application specification in SMDL or conversion of the application specification into SMDL, a container instance that may be utilized to run the container set is determined, as in 304. As discussed above, the application specification may include information as to the hardware configuration, networking, and/or other resources that are necessary to host and run the container set that includes the application. Based on that information and the availability of existing container instances, an available container instance that is capable of being configured to meet the requirements for the container set, as indicated in the SMDL application specification, is determined. In some implementations, the container set manager 273, executing on the control plane, may determine the container instance that will be utilized to host the container set on the data plane. In other implementations, the request to run the container set may include an indication of the container instance upon which the container set is to be run. For example, the orchestrator may specify the container instance for the container set. In such a configuration, the container instance selected at block 304 may be the container instance specified in the request.

Upon determination of a container instance, the current state of the container instance is determined, as in 306. In some implementations, a snapshot of the current state may be generated and maintained by the example process 300 in the event the container instance needs to be reverted back to the current state (e.g., a power cycle of the container instance occurs during the example process 300). Likewise, a desired state of the container instance that is needed to properly run the container set is determined, as in 308. The desired state may be determined from the SMDL application specification based on the resources and configuration specified in the application specification. Similar to selecting the container instance, the container set manager 273 may determine one or both of the current state of the container instance and the desired state of the container instance.

Based on the determined current state of the container instance and the desired state for the container instance, an operation set that includes one or more operations and an order of completion of those operations that are to be performed to transition the container instance from the current state to the desired state is generated or precomputed, as in 310. As discussed above, when configuring a container instance for a container set, there are specific defined operations that must be performed for all, or almost all, container sets (e.g., create a new network interface, create a new network namespace, download a particular set of files/container images, start process from the downloaded files, etc.). In traditional systems, determination and execution of such operations was all done by the thick software client executing on the container instance in the data plane. In comparison, in accordance with the disclosed implementations, the operations set and order of operations in the operation set is precomputed and generated by the container set manager 273 that is logically separate from the selected container instance.

Once the operations set and order of operations is determined/precomputed, a first operation from the operation set is pushed to the agent on the selected compute instance for execution, as in 312. In some implementations, after the container set manager 273 generates an operation set 274, the operation set may be provided to a workflow manager 275 that is logically separate from the selected container instance. The workflow manager 275 may then push an operation from the operation set to an agent 278 of the selected container instance 112, for example through a proxy 276. As discussed above, the workflow manager may communicate with multiple proxies that send operations and receive replies from multiple different container instances on the data plane 290. Likewise, each proxy may communicate with one or more container instances.

Again, in comparison to traditional systems in which the entire application specification is provided to the thick software client executing on the container instance, in response to the thick software client polling the orchestrator for work, and the thick software client being responsible for determining and configuring the container instance and launching the container instance, with the disclosed implementations, the agent executing on the container instance may be small and agnostic of the orchestrator that generated the application specification. Likewise, the agent executing on the container instance may be configured to await an operation, which is pushed to the agent (rather than pulled by a thick software client), and upon receipt of the operation, perform the operation and provide an acknowledgement back to the workflow manager confirming that the operation has been completed.

Returning to FIG. 3, after pushing the operation to the agent, the example process 300 determines if an acknowledgement has been received from the agent confirming that the agent has completed the operation, as in 314. If it is determined that an acknowledgment has been received, the example process 300 determines if there are additional operations in the operation set that remain to be completed by the agent, as in 316. If one or more operations remain that have not yet been pushed to the agent for completion, a next operation in the ordered operation set is sent to the agent for execution, as in 318, and the example process 300 returns to block 314 and continues. In some implementations, after each operation is acknowledged or after a group or batch of operations have been completed and acknowledged, the example process may generate a snapshot indicative of the state of the container instance at that time. In other implementations, as noted below, only a snapshot of the current state of the container instance, determined at block 306, and a snapshot of the state of the container instance when all operations of the operation set have been performed and acknowledged such that the container instance is in the desired state may be generated. If it is determined that all operations of the operation set have been sent to the agent and the agent has acknowledged completion of each, the example process 300 completes, as in 320. As mentioned, completion of the example process 300, at block 320, may include generating a snapshot of the container instance at the desired state.

Returning to decision block 314, if it is determined that an acknowledgement has not been received (e.g., after a defined period of time), the example process 300 may determine if a retry of the operation should be performed, as in 322. In some implementations, the example process 300 may be configured to retry an operation a defined number of times (e.g., three times). In such an example, if an acknowledgement has not been received and the operation has not been retried the defined number of times, the example process 300 may determine that a retry of the operation is to be performed. If a retry is to be performed, the same operation is resent to the CI agent, as in 324. In comparison, if the operation has been retried the defined number of times, or if it is otherwise determined at decision block 322 that a retry is not to be performed, it may be determined whether the operation set is to be restarted, as in 326.

If it is determined that the operation set is to be restarted, the container instance may be reset to the current state determined at block 306 (for example by using a current state snapshot generated when the current state of the container instance was originally determined), as in block 328, and the first operation of the operation set sent to the CI agent for completion, as in 312. If it is determined at decision block 326 that the operation set is not to be restarted, the container instance may be reset to a known state, such as the current state determined at block 306, the container instance may be shut down, and/or other operations may be performed to revert the container instance to a stable state, as in 330.

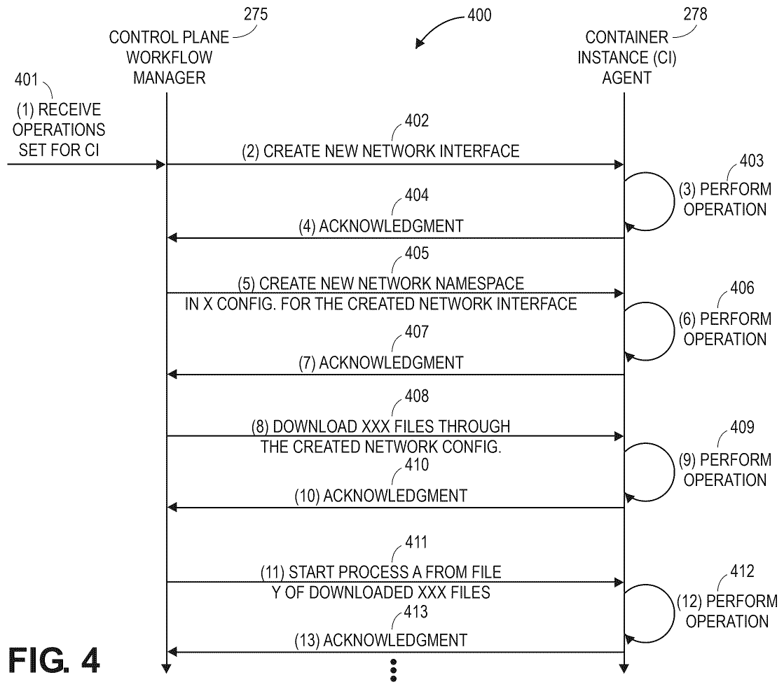

FIG. 4 is an example transition diagram 400 of instructing an agent of a container instance to complete a series of operations to configure a container instance for a container set, in accordance with disclosed implementations. The example transition diagram 400 indicates an example sequence of operations that may be pushed to an agent of a container instance as part of a workflow manager executing in the control plane configuring the container instance for a container set. It will be appreciated that the operations and the order of operations presented and discussed with respect to FIG. 4 are illustrative only and that other operations and/or orders of operations may be pushed by the workflow manager to an agent as part of configuring a container instance for a container set.

In the illustrated example, the operations set, which includes the operations of “create new network interface,” “create new network namespace in X configuration for the created network namespace,” “download XXX files through the created network configuration,” “start process from file Y of downloaded XXX files,” etc., is received 401 by the workflow manager 275 executing on the control plane. As discussed above, the operation set that includes the order set of operations may be generated by a container set manager 273 that is executing on the control plane 250.

In accordance with the disclosed implementations, the workflow manager 275, upon receipt of the operations set, may push to the agent executing on a selected container instance a first operation of the operation set. In this example, the first operation of “create a new network namespace” is pushed by the workflow manager 275 from the control plane 250 to the agent 278, for example through a proxy 276.

The agent, upon receipt of the operation, performs 403 the operation with respect to the compute instance, in this example by creating a new network interface 402. Once the agent has completed the operation, the agent sends an acknowledgement 404 to the workflow manager indicating that the operation has been successfully completed by the agent. The agent then returns to a wait state and awaits a next operation from the workflow manager.

The workflow manager 275, upon receipt of the acknowledgement 404, pushes to the agent a next ordered operation from the operation set for performance by the agent 278. In this example, the second operation that is pushed 405 from the workflow manager to the agent is the operation of “create a new network namespace in X configuration for the created network interface,” where X may be determined and specific in the operation set when the operation set is generated by the container set manager.

The agent, upon receipt of the operation, performs 406 the operation with respect to the compute instance, in this example by creating a new network namespace in X configuration for the created namespace. Once the agent has completed the operation, the agent sends an acknowledgement 407 to the workflow manager indicating that the operation has been successfully completed by the agent. The agent then returns to a wait state and awaits a next operation from the workflow manager.

The workflow manager 275, upon receipt of the acknowledgement 407, pushes to the agent a next ordered operation from the operation set for performance by the agent 278. In this example, the third operation that is pushed 408 from the workflow manager to the agent is the operation of “download XXX files through the created network configuration,” where XXX files may be determined and specific in the operation set when the operation set is generated by the container set manager.

The agent, upon receipt of the operation, performs 409 the operation with respect to the compute instance, in this example by downloading XXX files through the created network configuration. Once the agent has completed the operation, the agent sends an acknowledgement 410 to the workflow manager indicating that the operation has been successfully completed by the agent. The agent then returns to a wait state and awaits a next operation from the workflow manager.

The workflow manager 275, upon receipt of the acknowledgement 410, pushes to the agent a next ordered operation from the operation set for performance by the agent 278. In this example, the fourth operation that is pushed 411 from the workflow manager to the agent is the operation of “start process A from file Y of downloaded XXX files,” where process A and file Y may be determined and specific in the operation set when the operation set is generated by the container set manager.

The agent, upon receipt of the operation, performs 412 the operation with respect to the compute instance, in this example by starting process A from file Y of the downloaded XXX files. Once the agent has completed the operation, the agent sends an acknowledgement 413 to the workflow manager indicating that the operation has been successfully completed by the agent. The agent then returns to a wait state and awaits a next operation from the workflow manager.

This exchange of pushing an operation to the agent, the agent performing the operation, and the agent sending an acknowledgement upon successful completion of the operation may be continued until the container instance is configured and the application(s), container, or other workloads are running on the container instance.

While the examples discussed above describe pushing a single operation at a time to the agent for execution, in some implementations more than one operation of an operation set may be sent to the agent at a time, for example in operation batches. As an example, and referring to the above discussion with respect to FIG. 4, in some implementations, operations relating to network configuration, such as create a new network interface and create a new network namespace, may be pushed as an operation batch for performance by the agent. In such an example, when the agent has successfully completed the batch of operations, the agent may send an acknowledgement to the workflow manager indicating that the batch of operations has been successfully completed.

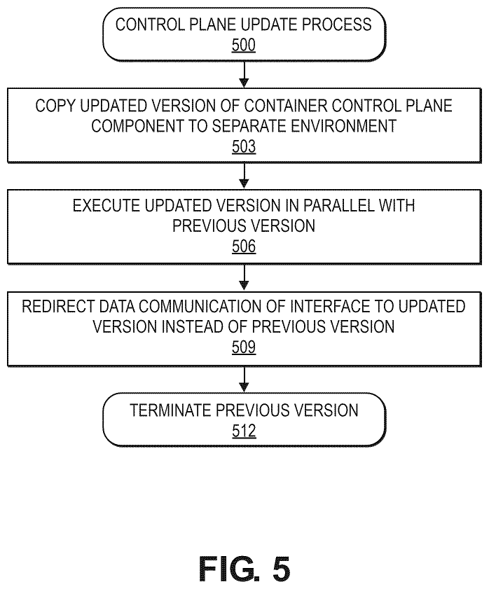

FIG. 5 is an example control plane update process 500 for updating portions of a control plane of the networked environment of FIGS. 2A and/or 2B, in accordance with disclosed implementations.

The example process 500 begins by copying an updated version of a component of the control plane 114 (FIGS. 2A and 2B), such as the workflow manager, the container set manager, etc., to an environment in which the component is executed separately from machine instances that are executing on the data plane, as in 503. In various implementations, the updated versions may be copied to an off-load device 118 (FIGS. 2A and 2B) or to a substrate machine instance 245 (FIGS. 2A and 2B).

An updated version of the copied component may then be executed in parallel with the previous version, as in 506. The data communication into and/or out of the copied component may then be updated to point to the updated version instead of the previous version that was copied to the separate environment, as in 509. For example, the communication between the proxy and the workflow manager may be updated by the example process to point to the updated version of the workflow manager instead of the previous version of the workflow manager that was copied to a separate environment.

Finally, the previous version of the component that was copied to the separate environment, such that the previous version of the workflow manager, may be terminated, as in 512, thereby completing the example process 500. Because the agent and the proxy are now interacting with the updated version of the workflow manager and/or other updated components of the control plane, terminating the previous version does not impact the operation of the container instances 112 and/or applications running on the container instances.

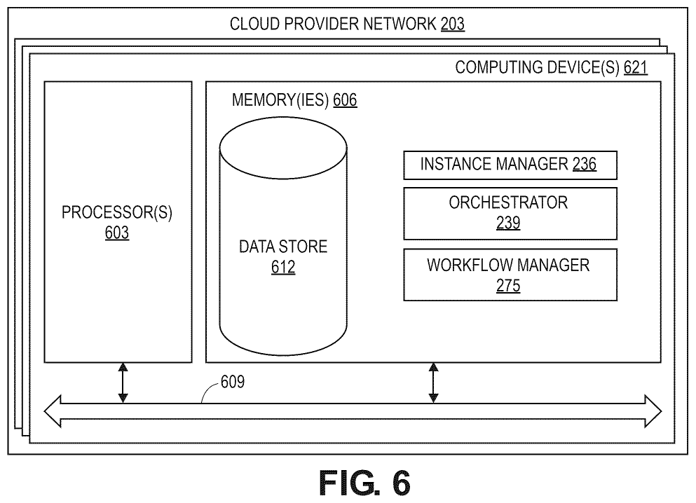

FIG. 6 is an example schematic block diagram of the cloud provider network 203, in accordance with disclosed implementations. The cloud provider network 203 includes one or more computing devices 621. Each computing device 621 includes at least one processor circuit, for example, having a processor 603 and a memory 606, both of which are coupled to a local interface 609. To this end, each computing device 621 may comprise, for example, at least one server computer or like device. The local interface 609 may comprise, for example, a data bus with an accompanying address/control bus or other bus structure as can be appreciated.

Stored in the memory 606 are both data and several components that are executable by the processor 603. In particular, stored in the memory 606 and executable by the processor 603 are the instance manager 236, the container orchestration service 239, the workflow manager 275, and potentially other applications. Also stored in the memory 606 may be a data store 612 and other data. In addition, an operating system may be stored in the memory 606 and executable by the processor 603.

It is understood that there may be other applications that are stored in the memory 606 and are executable by the processor 603 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 606 and are executable by the processor 603. In this respect, the term “executable” means a program file that is in a form that can ultimately be run by the processor 603. Examples of executable programs may be, for example, a compiled program that can be translated into machine code in a format that can be loaded into a random access portion of the memory 606 and run by the processor 603, source code that may be expressed in proper format such as object code that is capable of being loaded into a random access portion of the memory 606 and executed by the processor 603, or source code that may be interpreted by another executable program to generate instructions in a random access portion of the memory 606 to be executed by the processor 603, etc. An executable program may be stored in any portion or component of the memory 606 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 606 is defined herein as including both volatile and nonvolatile memory and data storage components. Volatile components are those that do not retain data values upon loss of power. Nonvolatile components are those that retain data upon a loss of power. Thus, the memory 606 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 603 may represent multiple processors 603 and/or multiple processor cores and the memory 606 may represent multiple memories 606 that operate in parallel processing circuits, respectively. In such a case, the local interface 609 may be an appropriate network that facilitates communication between any two of the multiple processors 603, between any processor 603 and any of the memories 606, or between any two of the memories 606, etc. The local interface 609 may comprise additional systems designed to coordinate this communication, including, for example, performing load balancing. The processor 603 may be of electrical or of some other available construction.

Although the instance manager 236, the container orchestration service 239, the workflow manager 275, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 3 and 5 show the functionality and operation of an implementation of portions of the cloud provider network 203. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 603 in a computer system or other system. The machine code may be converted from the source code, etc. If embodied in hardware, each block may represent a circuit or a number of interconnected circuits to implement the specified logical function(s).

Although the flowcharts of FIGS. 3 and 5 show a specific order of execution, it is understood that the order of execution may differ from that which is depicted. For example, the order of execution of two or more blocks may be scrambled relative to the order shown. Also, two or more blocks shown in succession in FIGS. 3 and 5 may be executed concurrently or with partial concurrence. Further, in some implementations, one or more of the blocks shown in FIGS. 3 and 5 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the instance manager 236, the container set manager 273, and the workflow manager 275, that comprises software or code can be embodied in any non-transitory computer-readable medium for use by or in connection with an instruction execution system such as, for example, a processor 603 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the instance manager 236, the container set manager 273, and the workflow manager 275, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 621, or in multiple computing devices 621 in the same cloud provider network 203.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain implementations require at least one of X, at least one of Y, or at least one of Z to each be present.

It should be emphasized that the above-described implementations of the present disclosure are merely possible examples of implementations set forth for a clear understanding of the principles of the disclosure. Many variations and modifications may be made to the above-described implementation(s) without departing substantially from the spirit and principles of the disclosure. All such modifications and variations are intended to be included herein within the scope of this disclosure and protected by the following claims.

1. A computer-implemented method, comprising:
receiving a request to run an application;
in response to the request:
determining a current state of a container instance within which the application may be run, wherein the container instance is operating in a data plane of a cloud provider network;
determining a desired state of the container instance that is needed to run the application;
determining, with a container set manager that is operating in a control plane of the cloud network provider, a plurality of operations to be performed at the container instance to transition the container instance from the current state to the desired state and run the application on the container instance, wherein the control plane runs on a first computing hardware that is at least one of physically or logically separated from a second computing hardware upon which the data plane and the container instance operates;
pushing, from the control plane and to an agent operating on the data plane, a first operation of the plurality of operations that is to be performed by the agent;
receiving, from the agent a first acknowledgement that the first operation has been completed;
in response to receiving the first acknowledgement, pushing, from the control plane and to the agent, a second operation of the plurality of operations that is to be performed by the agent;
receiving, from the agent a second acknowledgement that the second operation has been completed; and
determining, subsequent to receiving the second acknowledgement, that the container instance is in the desired state and that that application is running on the container instance; and
providing a confirmation that the application is running.

2. The computer-implemented method of claim 1, further comprising:
determining an order of operations for each operation of the plurality of operations; and
wherein the first operation is a first operation in the order of operations.

3. The computer-implemented method of claim 1, wherein receiving the request to run the application, includes:
receiving, from an orchestrator, an application specification indicating the request to run the application.

4. The computer-implemented method of claim 3, wherein determining the plurality of operations, includes:
determining, based at least in part on the application specification, one or more of the plurality of operations.

5. The computer-implemented method of claim 3, further comprising:
transforming the application specification from an orchestrator specific language to a general state machine definition language that may be used by the container set manager to determine operations of the plurality of operations.

6. A system, comprising:
a data plane of a cloud provider network, the data plane operating on at least a first computing device of the cloud provider network; and
a control plane of the cloud provider network, the control plane operating on at least a second computing device of the cloud provider network, the control plane configured to at least:
determine a current state of a container instance of the data plane;
determine a desired state of the container instance;
determine, based at least in part on the current state and the desired state, a plurality of operations to be performed at the container instance to transition the container instance from the current state to the desired state; and
push, from the control plane and to an agent of the data plane, each of the plurality of operations such that the agent causes each operation to be performed and the container instance to transition from the current state to the desired state.

7. The system of claim 6, wherein the control plane is further configured to at least:
determine an order of operations of the plurality of operations indicative of an order in which each operation is to be performed.

8. The system of claim 7, wherein:
the control plane pushes a second operation to the agent in response to receipt of an acknowledgement from the agent that a first operation has been completed; and
the second operation follows the first operation in the order.

9. The system of claim 6, wherein the control plane is further configured to at least:
receive a request to run an application; and
wherein the plurality of operations are further determined based at least in part on the current state of the container instance and the desired state of the container instance that is needed to run the application on the container instance.

10. The system of claim 6, wherein the control plane, as part of pushing each operation to the agent, is further configured to at least:
push a first operation of the plurality of operations to the agent;
receive, an acknowledgement from the agent indicating that the first operation is complete; and
in response to the acknowledgement, push a second operation of the plurality of operations to the agent.

11. The system of claim 6, wherein the agent operating on the data plane is a thin agent that awaits operations from the control plane, upon receipt of an operation, performs the operation, upon completion of the operation sends an acknowledgement to the control plane indicating that the operation is complete, and upon sending the acknowledgement, returns to a wait state and awaits a next operation from the control plane.

12. The system of claim 6, wherein the control plane is further configured to at least:
receive, from an orchestrator, an application specification that includes an indication of the application to be run on the data plane, wherein the application specification is specific to the orchestrator; and
translate the application specification from being specific to the orchestrator to a standardized application specification such that the control plane can determine, based at least in part on the standardized application specification, the plurality of operations.

13. The system of claim 6, wherein the control plane is further configured to at least:
determine a second current state of a second container instance of the data plane;
determine a second desired state of the second container instance;
determine, based at least in part on the second desired state, a second plurality of operations to be performed at the second container instance to transition the second container instance to the second desired state; and
push, from the control plane and to a second agent of the data plane, each of the second plurality of operations such that the second agent causes each operation of the second plurality of operations to be performed and the second container instance to transition from the second current state to the second desired state.

14. The system of claim 13, wherein the control plane is further configured to push each of the plurality of operations and each of the second plurality of operations through a proxy that communicates with the control plane, the agent, and the second agent.

15. The system of claim 6, wherein the control plane includes at least:
a container set manager configured to determine the plurality of operations; and
a workflow manager that pushes each operation of the plurality of operations to the agent.

16. A computer-implemented method, comprising:
determining, with a first component executing in a control plane of a cloud provider network, a desired state of a container instance of a data plane of the cloud provider network, wherein the control plane and the data plane are at least one of logically separated or physically separated on different computing hardware of the cloud provider network;
determining, with the first component and based at least in part on the desired state, a plurality of operations to be performed at the container instance to transition the container instance to the desired state; and
push, from a second component of the control plane and to an agent operating on the data plane, each of the plurality of operations such that the agent causes each operation to be performed and the container instance to transition from the current state to the desired state.

17. The computer-implemented method of claim 16, wherein the second component pushes operations to a plurality of agents of the data plane, wherein the agent is included in the plurality of agents.

18. The computer-implemented method of claim 16, further comprising:
updating at least one of the first component or the second component while an application is running on the container instance and without terminating the application.

19. The computer-implemented method of claim 16, further comprising:
determining an order of operations indicating an order in which each operation of the plurality of operations is to be performed.

20. The computer-implemented method of claim 19, wherein pushing includes:
pushing each operation of the plurality of operations to the agent according to the order of operations.
